(19) United States
(12) Patent Application Publication
(10) Pub. No.: US 2021/0326399 A1
(43) Pub. Date: Oct. 21, 2021

(54) System and Method for Search Engine Results Page Ranking with Artificial Neural Networks

(71) Applicant: Hudson Bay Wireless LLC, St. Thomas, VI (US)

(72) Inventor: Paul V. Hayes, Saint Thomas, VI (US)

(73) Assignee: Hudson Bay Wireless LLC, St. Thomas, VI (US)

(21) Appl. No.: 17/272,486

(22) PCT Filed: Aug. 29, 2019
(86) PCT No.: PCT/US19/48937

§ 371 Date: Mar. 1, 2021

Related U.S. Application Data
(60) Provisional application No. 62/724,102, filed on Aug. 29, 2018.
(60) Provisional application No. 62/748,561, filed on Oct. 22, 2018.

(51) Int. Cl. G06F 16/9535; G06F 16/9532; G06F 16/9538; G06F 16/951; G06N 3/04; G06N 3/08

(52) U.S. Cl. CPC G06F 16/9535; G06F 16/9532; G06F 16/9538; G06N 3/08; G06N 3/0445; G06N 3/0454; G06F 16/951

(57) ABSTRACT

A system and method for ranking search results. The system receives search results and uses an artificial neural network (ANN) to rank the results, wherein at least one of the inputs to the ANN is derived from a search query, and wherein the search query is processed as a visual image. An input to the ANN can include a user's profile and a search engine results page (SERF) produced by a search engine and presented to a user for review. An output of the ANN can include a re-ranking of an input SERF. The ANN can be trained and used in batch mode, periodically after saving results from multiple search sessions conducted by a plurality of users.

### RELATED APPLICATIONS

This application claims priority to U.S. Provisional Patent Application No. 62/724,102 filed on Aug. 29, 2018 and U.S. Provisional Patent Application No. 62/748,561 filed on Oct. 22, 2018, the entire disclosures of which are both incorporated herein.

### BACKGROUND

### Field of the Disclosure

The present disclosure relates to the field of computer search engine technology. More specifically, the present disclosure relates to systems and methods for search engine results page ranking with artificial neural networks (ANNs).

### Related Art

Popular search engines currently do text string matching techniques with queries for look-up indexed web content to prepare SERPs, using for example ASCII character codes. The use of the image or spoken voice for a query string is a more natural, organic input to an ANN and captures more information concerning a searcher's speech community. The image of a user's entered query, or the voice recording of the user's spoken query is directly applied to the ANN so as to capture an maximum amount of information content in the query. First translating this to a character string destroys information contained in the original query that is useful in identifying the speech community a searcher is a member of. This is advantageous in better identifying speech community membership and in turn facilitates better ranking of SERPS or particular profiles.

The present disclosure minimizes the training time of the ANN and trains it in a manner that produces optimal ability to accurately ‘generalize’—so as to properly rank a SERP based on inputs not used during training of the ANN. The present system uses images of typed queries, and spoken voice queries, directly, as training data, to reduce training time, improve the quality of training and improve the ability of the ANNs to generalize. As such, less information is lost by use of images and voice; compared to first converting images and voice to, for example, ASCII character codes.

### SUMMARY

The present disclosure relates to systems and method for search engine results page ranking with artificial neural networks (ANN), which uses deep learning techniques for structuring the artificial neural network. The task of the ANN is to learn to order search result abstracts, in such a manner that they agree with the order, that a searcher believes is appropriate, as inferred by the present system. The ANN does this by taking as inputs an initial Search Engine Result Page (SERP), the searcher's query, and the searcher's structured profile. To take advantage of the fact that searchers who are members of similar speech communities enter similar queries, with similar meaning, the present system processes and represents verbal queries as voice, and non-verbal queries as visual imagery, for application to the neural network inputs. This technique is contrasted with methods which represent, for example, query text strings as ASCII code and matching these text strings to indexed content, as scraped by crawlers from web pages or documents which have been stored as ASCII code. The present system makes it easier to train the ANN (learning task is simplified) since the information content of similar queries can be more readily recognized by the ANN. The present system also improves the ability of a trained ANN to generalize correctly to produce more accurate SERP rankings for inputs not previously seen (e.g. not used for training) by the ANN.

### BRIEF DESCRIPTION OF THE DRAWINGS

The foregoing features of the disclosure will be apparent from the following Detailed Description, taken in connection with the accompanying drawings, in which:

FIGS. 1-6 are diagrams illustrating the system of the present disclosure;

FIG. 7 is a diagram illustrating an input/output structure of the ranking neural network of the present disclosure;

FIG. 8 is a diagram illustrating a process of training a Recurrent Neural Network (“RNN”) of the present disclosure to output a Suggested Alternate Query (SAQ);

FIG. 9 is a table showing an example of language profile representations for input into the artificial neural network (ANN) of the present disclosure;

FIGS. 10A-15B are illustrations of ANNs of the present disclosure;

FIG. 16 is a sample training database record;

FIGS. 17-18 are illustrating showing a method for processing of searcher data for SERP ranking in accordance with the present disclosure;

FIG. 19 is an illustration showing a generational training and ranking ANN;

FIG. 20 is a simplified profile to increase one-way hash matches; and

FIG. 21 is an illustration showing a composite profile voice generation of the present disclosure.

### DETAILED DESCRIPTION

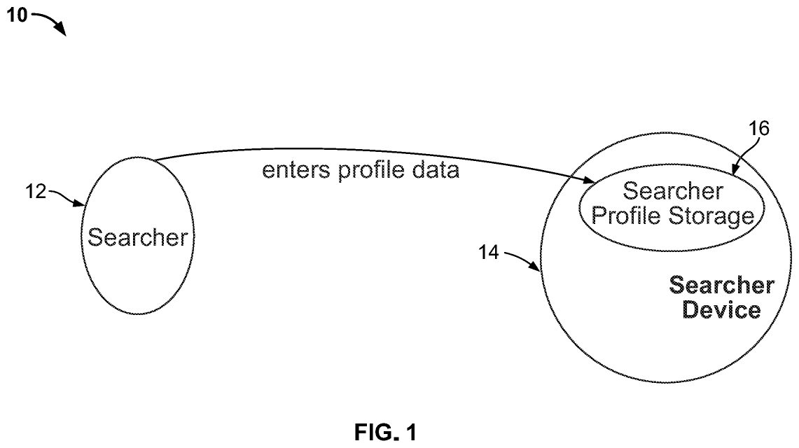

The present disclosure relates to a system and method for search engine results page ranking with artificial neural networks, as discussed in detail below in connection with FIG. 1-21.

FIGS. 1-6 are diagrams, indicated generally at 10, illustrating hardware and software components of the system of the present disclosure. Specifically, FIGS. 1-6 illustrate a buildup of the overall system 10, and discusses the components of the system 10. It is noted that the system of the present disclosure may be referred to using the term “Grabhat,” and doesn't include all of the component of the system of the present disclosure (e.g., the Grabhat system). Furthermore, components of the system of the present disclosure may be referred to using the term “Grabhat,” followed by the type of component.

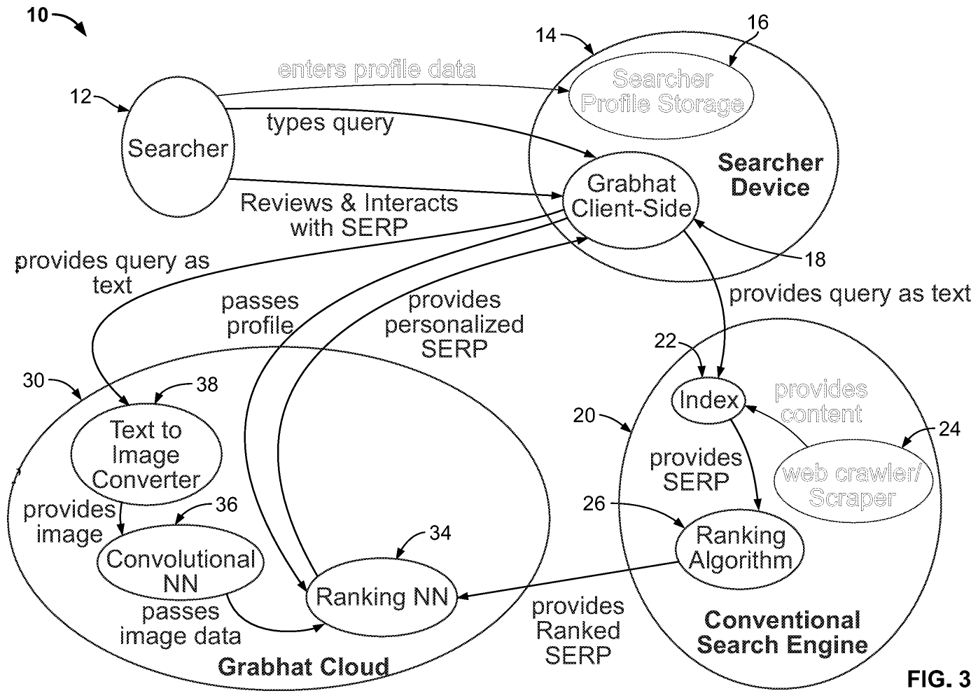

FIG. 1 is a diagram showing a user's 12 (e.g., a searcher) interaction with a client of the overall system 10 installed on the user's 12 user device 14 to enter a profile 16 of the user 12. The user device 14 can include a desktop, a tablet, a laptop, smartphone, a private area in the cloud, etc. The profile 16 can be set up only once, or again in the event of profile change or loss of a profile. The profile 16 can be stored on the user's device 14. The user 12 can own and controls the content of the profile 16 and decide whether or not to enter the profile 16 and whether or not to share the profile 16 at any point in time. In order to benefit from use of the profile 16 with a Grabhat search engine (which will be discussed in detail below), the user 12 authenticates their identity with a Trusted Third Party (TPP). Once the TPP verifies that the user 12 is a real person having the proper identify, the user 12 is issued a certificate or token which is used to validate communication with the Grabhat system. The TPP can also send a copy of the certificate to a Grabhat Cloud (server-side) 30 (as seen in FIGS. 3-6). The TPP does not see the profile 16 and only authenticates the user's 12 identity. The Grabhat system never sees the identity of the user and uses the certificate to verify they are a real person. In this manner the user's privacy is insured.

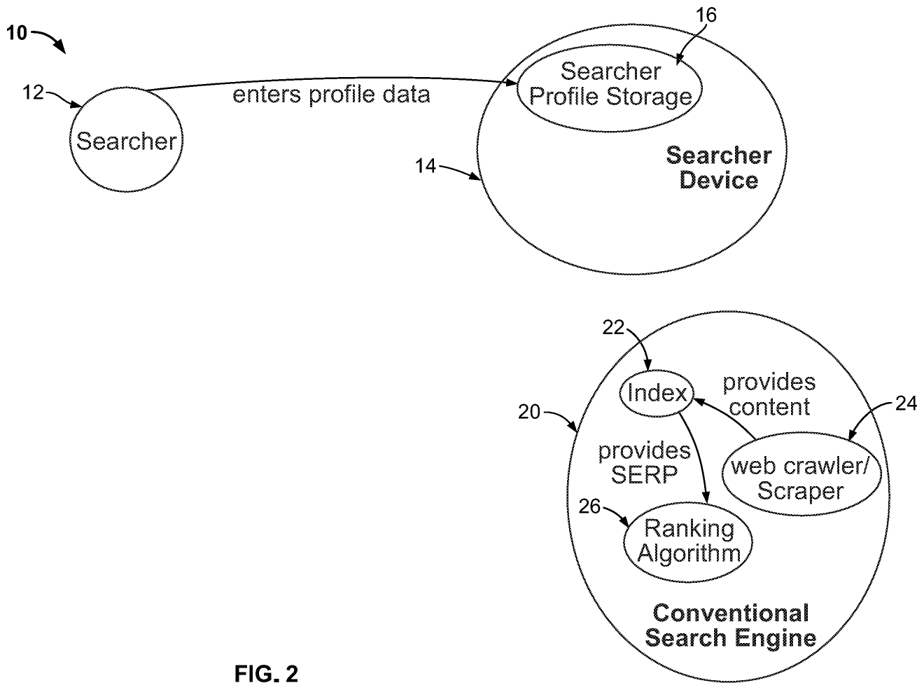

FIG. 2 is a diagram illustrating an operation of a conventional search engine 20 of the system 10 which crawls and scrapes the World Wide Web and indexes content for future use in matching query text to content and generation of SERPs; and in using essentially link-based ranking techniques to order the SERPs. The system 10 can initially make use of the conventional search engine 20 (e.g., Gigablast, DuckDuckGo, Google, etc.) for the above operations. Grabhat machine learning can re-order an upper portion of the SERP provided by the conventional search engine 20. The operation of the conventional search engine 20, also referred to as a foreign search engine, is assumed to be conducted independently from Grabhat operation. In some embodiments of this invention, the Grabhat machine learning can progress to the point that a larger number of URLs can be organized into a SERP by the Grabhat system without reliance on a foreign search engine and that the Grabhat system can conduct its own web crawling, indexing, and initial ranking for content.

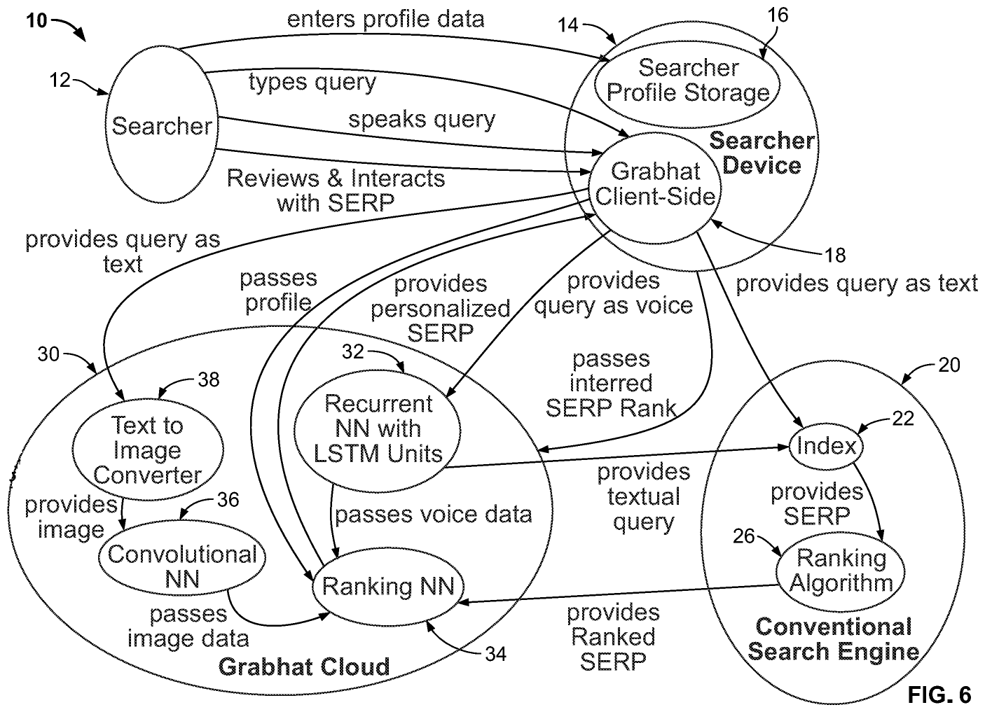

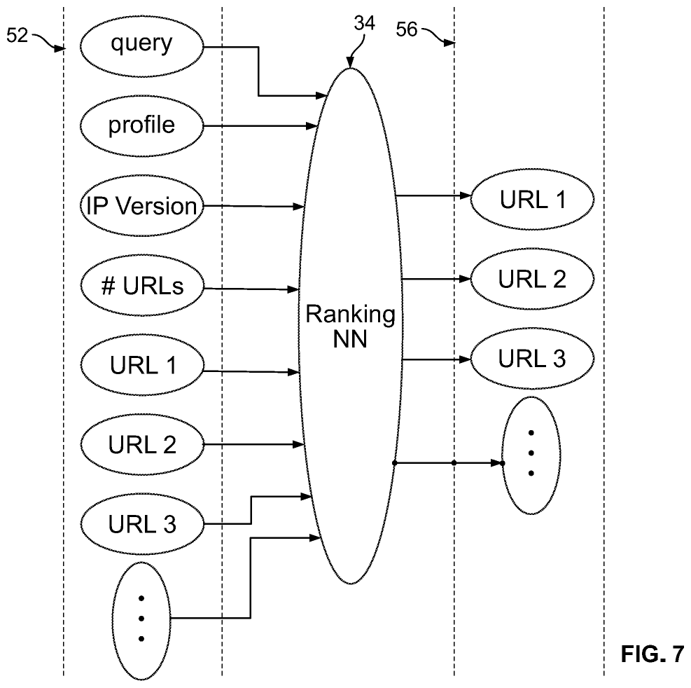

FIG. 3 is a diagram illustrating the system 10 in a case when the user 12 types a query as input to a Grabhat Client 18. The query is sent by the Grabhat Client 18 to the conventional search engine 20 and to a Grabhat Cloud 30. The query contains all formatting of text & font used by the user 12, and is converted to an image (via a text to image converter 38) prior to application to a convolutional neural network (“CNN”) 36. The Grabhat Client 18 also passes the user' profile 16 to the Grabhat Cloud 30. The conventional search engine 20 receives the text-based query and uses it to produce a SERP. The SERP is passed to the Grabhat Cloud 30. At this point the SERP, the profile 16, and the query image are inputs to a ranking neural network 34 within the Grabhat Cloud 30. The ranking neural network 34 serves to produce a potentially new ordering of the input SERP. This newly ordered SERP is provided back to the Grabhat Client 18 and presented to the user 12. The Grabhat Client 18 then monitors the user's 12 interaction with the provided SERP and from this interaction infers the opinion of the user 12 as to the most relevant ordering of the SERP, if different than that provided. This inferred opinion is then transmitted back for further training of the ranking neural network 34 at the Grabhat Cloud 30, as shown in FIGS. 6 and 7.

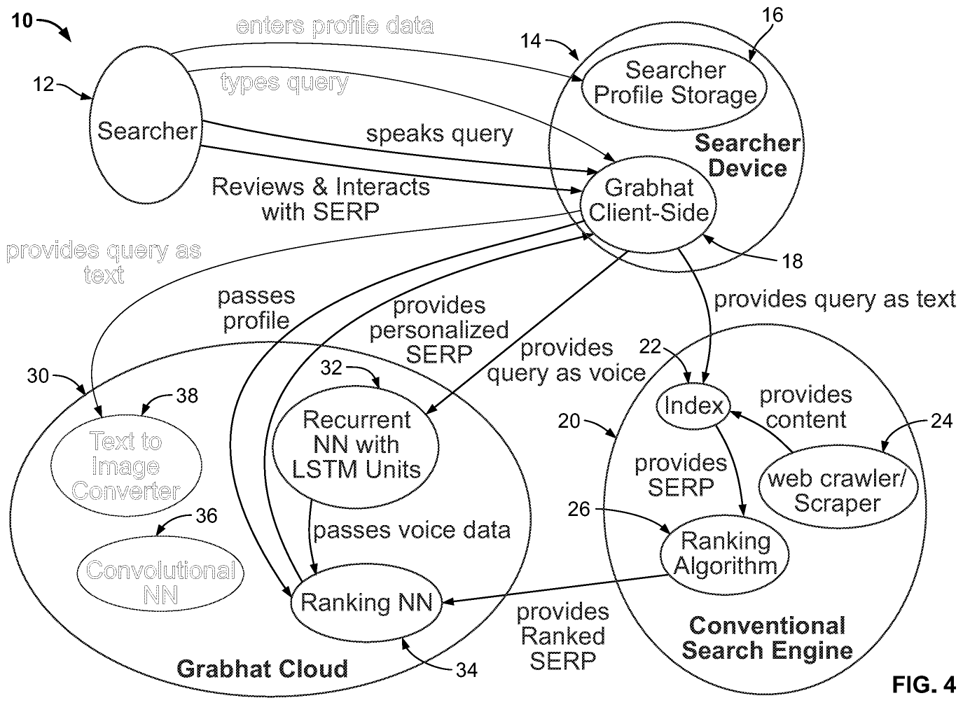

FIG. 4 is a diagram illustrating the system 10 in a process, similar to that shown in FIG. 3, except that the user 12 uses voice to enter a query. The voice query is recorded by the user device 14 and transmitted by the Grabhat Client 18 to the Grabhat Cloud 30. Speech recognition software within either the Grabhat Client 18 or the Grabhat Cloud 30 is used to produce a textual version of the query, which is sent to the conventional search engine 20. FIG. 4 shows the textual query being produced by the Grabhat Client 18. The voice is input to a Recurrent Neural Network (RNN) 32 within the Grabhat Cloud 30 which uses Long Short-term Memory Units to better process the voice query. The output result of the RNN 32 is used as input to the Ranking neural network 32, along with the profile 16 and the SERP received from the conventional search engine 20. The ranking neural network 34 then outputs a potential re-ranking of the search result abstracts (represented by links to URLs) contained in the SERP. The re-ranking personalizes the SERP for benefit of the user 12. The re-ranked SERP is then transmitted to the Grabhat Client 18 and presented to the user 12 for review. As when the user 12 types in a query (as discussed in FIG. 3), the Grabhat Client 18 monitors the user's 12 interaction with the SERP and infers the user's ranking preference. This inference is then transmitted back to the Grabhat Cloud 30 for future use in re-training the ranking neural network 34.

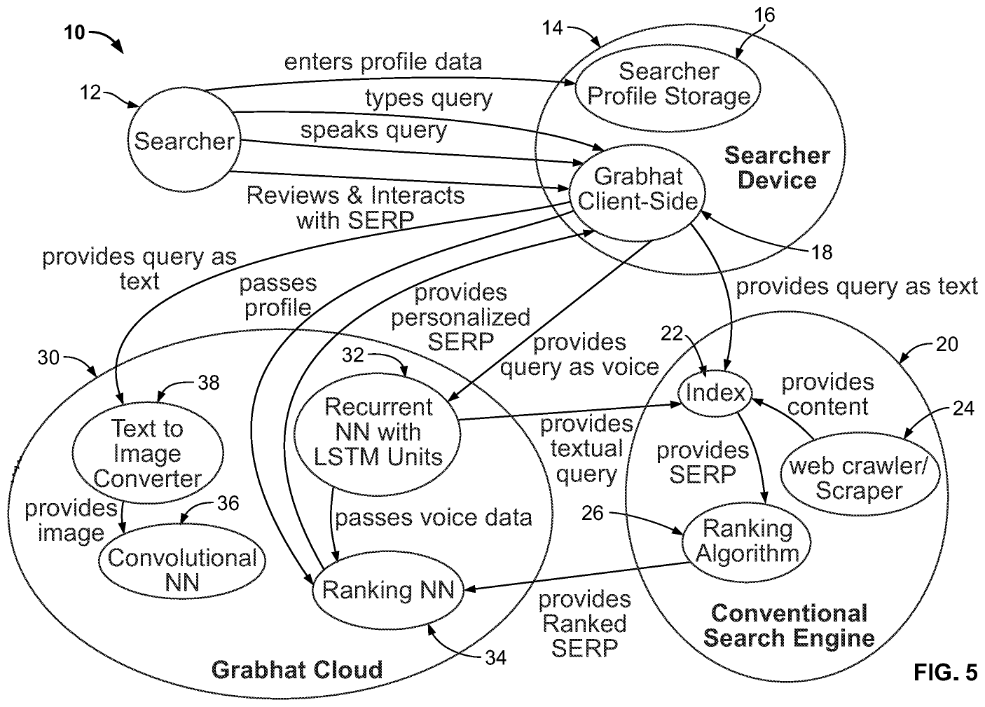

FIG. 5 is a diagram illustrating a combined overall operation of the Grabhat system of profile collection and storage, conventional search engine 20 use, and either voice or image query entry by the searcher; previously discussed in FIGS. 1-4. FIG. 6 is a diagram illustrating overall operation of the system 10 with the addition of the feedback provided to the Grabhat Cloud 30 from the Grabhat Client 18 representing user interaction with the SERP. FIG. 6 differs from FIG. 5 in that FIG. 6 also shows the feedback from the Grabhat Client 18 to the Grabhat Cloud 30 of the user's interaction with the SERP (e.g. inferred SERP rank).

FIG. 7 is a diagram illustrating an input/output structure of the ranking neural network 34 with simplifications for example, for the profile input, and the query input. The SERP inputs (input column 52) are expanded, as this is of particular importance to the neural network 34 (e.g., an artificial neural network) for training, since the training produces a desired order (output column 56), e.g., a re-ordering, of the SERP to be provided to the user 12.

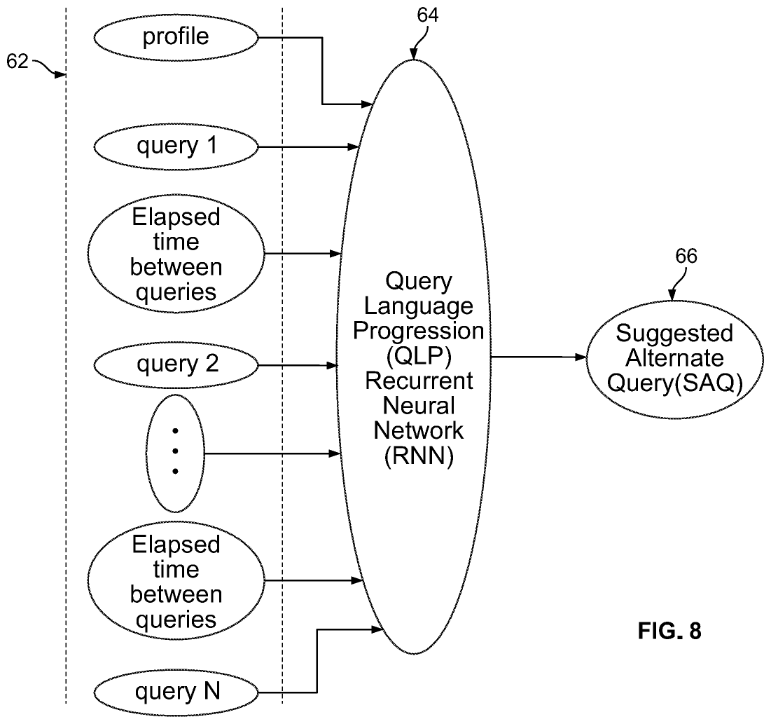

FIG. 8 is a diagram illustrating the process of training a Recurrent Neural Network (“RNN”) 64 to output a Suggested Alternate Query (SAQ) 66 by being presented with a user profile 16 and one or more queries. Note that the ending query entered in the past by other searcher(s) is the target output to train the RNN 64 against. In a preferred instance of the invention, the input training queries 62 to the QLP RNN are represented as images, textual character strings and speech. Thus in the preferred instance of this invention each input query is applied to the RNN 64 for training and/or for use, in three representations (text, image, and speech). If only one of these three representations is obtained from the user 12, the other two can be generated prior to training the QLP RNN 64. All three types of query representation are supplied to the RNN 64 simultaneously for each query in the QLP for both training and predictive use. The SAQ 66 is then presented to the user 12 selectively, under user control, as any or all of the three forms (text, image, or speech). All three representations (text, image, and speech) are used in order to allow the RNN 64 to train more quickly and generalize better to new queries not trained with; and to be less dependent on one form or the other.

The following sections discuss the system in more technical detail.

### Profile Attribute Representation Details (E.g. Number and Type of Neural Network Inputs)

The following is a list of profile attributes can be used by the Grabhat system as neural network inputs. At the end of some of the profile attributes, a uniform resource locator (“URL”) is provided by way of example only.
1) Age in years/months. One neural network integer input—total # months.
2) Top 3 Languages used—in order learned, level—understand, speak, read, write. Languages—http://www.muturzikin.com/languages.htm
   (over 7000 alphabetical, by region/country). 12 NN inputs, three integer (language), and 4 binary (0 or 1) for level of each language.
3) Locations/durations lived—Chronological order from date of birth, max of 3 locations, duration of 6 months or more—(Geo location)—http://www.muturzikin.com/languages.htm
4) Highest education level attained—Grade, degree (BS, MS, PhD). One integer NN input with grade 1-12, BS=16, MS=18, PhD=20
5) Professions practiced/durations—Profession, location, dates from/to (year & month only)—https://www.123test.com/professions/
   Entries only for professions of duration 1 year or more. Top two professions. Six NN integer inputs total, one for each profession, one for each location, and one for number of months worked at each.
6) College University name—if attended at least 1 year (dates from/to, year/month only)—https://en.wikipedia.org/wiki/Lists_of_universities_and_colleges_by_country
   Max of two campuses—Two integer neural network inputs, one for university and one for duration attended, in months.
7) Gender—http://abcnews.go.com/blogs/headlines/2014/02/heres-a-list-of-58-gender-options-for-facebook-users/
   One integer neural network input.
8) Race—https://en.wikipedia.org/wiki/List_of_contemporary_ethnic_groups
   One integer neural network input.
9) Religion—https://en.wikipedia.org/wiki/List_of_religions_and_spiritual_traditions
   One integer neural network input.
10) Favorite book—ISBN—https://en.wikipedia.org/wiki/International_Standard_Book_Number
   One integer neural network input, using 13-digit ISBN format.
11) Favorite movie—Movies—https://en.wikipedia.org/wiki/Universal_Product_Code
   One integer neural network input, using ISBN 13-digit format.
12) Favorite game—Games—https://en.wikipedia.org/wiki/Universal_Product_Code
   One integer neural network input
13) Favorite hobby—https://en.wikipedia.org/wiki/List_of_hobbies
   One integer neural network input
14) Class—https://www.cliffsnotes.com/study-guides/sociology/social-and-global-stratification/types-of-social-classes-of-people
   One integer neural network input.
15) Economic mobility—upward (1) or downward (0), in relation to parents and/or grandparents. One binary input to neural network.
16) Number of Siblings, and searcher's birth order. Two integer inputs to the neural network.
17) Top 2 Online Social networks used—https://makeawebsitehub.com/social-media-sites/Two integer inputs to the neural network.
18) Marital status: Every married/partnered, # children, ever divorced.
   One binary inputs to the neural network—0=never married/partnered, 1—married/partnered.
   One integer input to the neural network for number of children.
   One binary input to the neural network—0=never divorced, 1—divorced at least once.
19) Primary country of Citizenship—alphabetical list of countries—https://www.britannica.com/topic/list-of-countries-1993160
   One integer input to the neural network.

### SERP Result Abstract Representation

Representation of URL's for Search Result Abstracts can use the underlying IP address, with a unique addition indicating the balance of the URL (i.e. file/path names, extensions, etc). The IP address resolves to a series of integer numbers (4 for IPv4 and 8 for IPv6). Each of these sets of integers can be further resolved to a single integer, using the significance of the order of the numbers. In the preferred embodiment of this invention there are two inputs to the ANN, one to indicate either IpV4-0, or Ipv6-1; and another input of an integer number indicating the decimal integer equivalent to the IP address.

In addition to the IP address, an additional input can be presented to the ANN which is an integer representing the location of the content within the site the top-level IP address points to. In one instance of the present invention, the order of only the top 10 result abstracts (URLs) in the SERP are used. In some instances of the invention, only the top 5 or even just the top 3 result abstracts can be ordered. A smaller SERP makes for faster execution time, lower cost, but likely less quality. Larger SERPs may be used to improve quality, perhaps SERPs containing 100 URLs or more, if available can be used, cost and time permitting. In an instance of the present disclosure, the Grabhat system can crawl and scrape the Internet and organize content as image/voice data to facilitate matching query and profile to most relevant content for any number of URLs per SERP.

### Query Representation

Regardless of the language a user may enter a query with a keyboard, or by voice; for example. For purposes of this disclosure, entry of the query by spoken voice is best, as it contains the most information about how the user uses language. Such things as speech rhythm, pauses, inflection, intonation, volume, and accent are captured.

When the user enters the query using a keyboard, for example, to type characters, there is not as much information conveyed; as conveyed by voice or even hand-written queries. The information content of handwritten text is higher as it contains a searcher's unique style. The present system can represent both hand-written (via pencil, paint brush, stylus, mouse or other pointing device, etc.) and keyboard entries as images, in order to preserve and use as much of the information the searcher entered as possible. Others may convert typed text to numbers associated with ASCII characters. The present system can capture keyboard entries in an image, to preserve as much of the information as possible, including the searcher's choice of punctuation, use of capitalization, choice of font, and all the grammar and spelling as entered.

To simplify ANN training and optimize resulting ANN generalization, the present system treats entire (non-verbal) queries as if they were images. This takes advantage of the recent ‘deep learning’ advances of convolutional neural networks (CNNs). This approach takes advantage of the fact that similar queries (entered by similarly profiled searchers) are likely to contain portions which are visually identical; and/or which look similar to each other and which may contain clues as to a user's speech community membership. Another advantage of this approach is that it allows use of the same ANN structure and training sessions (number of inputs, layers, and connection strategy) to handle multiple searcher languages. In one instance of the present system, the color of the font used can be captured and utilized. In a preferred instance of the present system all queries can be treated as gray scale images, in order to simplify training of the NNs.

### ResultRank (Grabhat Re-ranking)

The present system stores the following data for each search session: [query, profile, SERP, ResultRank]. This data can only be saved if the certificate is valid. In one instance of the present system, the SERP may be only the top 5 result abstracts each represented by unique URL. The URLs can be stored in the order provided by the foreign search engine (i.e. Gigablast—presumed to use link-based ranking). In this instance of the present system, inferred user re-ranking can be represented as a 5-digit integer made up of any of the integers 1 through 5, each representing the relevance order of the result abstracts returned by a search engine (e.g., Gigablast), as inferred from searcher interaction with the SERP. For example, if Gigablast produces the 5 URLs ordered 1, 2, 3, 4, and 5; and the present system infers from the session events that the user believes URL #2 is the most relevant, then the inference of user re-ranking can be represented by the integer ‘21345’. Thus, storage of any integer other than 12345 can indicate that an inference of searcher re-ranking was made. This condensed representation of order is used to convey searcher judgment, as inferred, back to the Grabhat Cloud 30; in order to reduce the amount of data that need be transmitted. Herein, the previous definition of ResultRank is broadened to account for relative order rather than an absolute number indicating rank, as the inferred rank is the rank resulting from searcher review and interaction with the results, to more generally refer to the order of multiple result abstracts in a SERP. There can be an input to the ANN for every result abstract (URL) in the portion of the SERP inferred to have been re-ranked by the user. It can be expected that the user may not review the SERP beyond the top 10 results. Should experience show this assumption to be incorrect, more inputs can be added to the ANN to accommodate. The present system uses an additional input which is the integer number of URLs in the SERP being used as a training target for the output of the ANN. Any unused URL inputs to the ANN can be presented with a ‘0’ value. Note that unused ANN URL inputs may result if a particular user interacts with only the top 3 result abstracts in the SERP, for example, yet the Ranking ANN in use in the Grabhat Cloud 30 is structured and pre-trained to accommodate up to 5 inputs for URLs.

### Monitoring User Interaction with a SERP

The following steps can implemented in the Grabhat Client 18 to monitor user interaction with a SERP. First, the Grabhat Client 18 records an absolute time a SERP is 1^{st} presented to a user. Next, the Grabhat Client 18 records all events involving result abstracts, with timestamps relative to elapsed time since SERP presentation, including the inferred conclusion time of the session. Events can include in-order click-throughs, out-of-order click-throughs, click-pasts, and search session end. Click-through events are followed by at least a 5 second dwell time on the abstract clicked-through on, if there is a 2^{nd} out-of-order clickthrough during the same session, else at least 3 seconds if the user ends the session as the next event.

A decision or inference, as to whether or not the user re-ranked the search engine SERP during the search session can be determined locally by the Grabhat client 18 and communicated back to the Grabhat Cloud 30 as follow. In the case that the foreign search engine (e.g., Gigablast) has search abstract order of 1, 2, 3, 4, 5, for example, and if there is a local determination/inference that the user has re-ranked the SERP, placing the 3 abstract as more relevant than the first abstract, by clicking on the 3^{rd} abstract in an out-of-order manner, then Grabhat client 18 can convey this by sending back a representation of the ordering: 3, 1, 2, 4, 5, as opposed to sending entire URL's for each abstract in the SERP.

The end of a search session can be inferred if sufficient time has elapsed with the focus not being on the SERP and instead on a result abstract, or if the user leaves the Grabhat client 18, or if there is no user (e.g., searching) activity for a significant amount of time. This decision can be amended if the user returns from a result abstract to the Grabhat client 18, within a reasonable time period, and interacts further with the SERP.

A method of inferring a user re-rank is as follows. If a click-through out of order is detected, then the present system changes order of ranking to place the 1^{st} abstract clicked-through on at the top of the list, pushing all other abstracts, by number, lower in the list. If an additional out-of-order click-though is detected in the same search session, the present system orders the next URLs such that the abstract clicked-through on, is just below the previously abstract clicked-through on etc.

### Training the SERP Ranking Neural Network

The ranking neural network 34 is trained to output a SERP order specific to an input searcher query and profile. The target output SERPs used are those inferred from searcher interaction with SERPs initially presented to the searcher. A training set of inputs to the neural network consisting of multiple sets of [query, profile, presented SERP] is used to train and/or re-train the ranking neural network 34 when an inference is made that the user 12 was satisfied with the relevance of a re-ordered SERP. If the Grabhat Client 18 cannot make a reliable inference as to user satisfaction, then no training set can be prepared based on that search session. Our inference of searcher preference as to order of SERP, is used as a target output of the neural network 34 to train it. In one instance of the present system, the re-ordered SERP, derived from monitoring searcher interaction with the provided SERP, is used for training the ranking neural network 34 only when the user 12 is deemed to be an expert in the field of the query, based on their profile. The training of the ranking neural network 34 can be performed offline while it is not used to produce SERPs for presentation to the user. Then once trained and having passed testing requirements, the re-trained ranking neural network 34 is cut-in for use by searchers to personalize their SERPs. The schedule for collecting new training sets and conducting off-line re-training can be coordinated based on the level of searcher activity in particular geographic areas of the world. In one instance of the present system, different ranking neural networks can be used for searchers with different sets of profiles, likely from different speech communities. There can be as many outputs of the ranking neural network as there are inputs to accommodate URLs in the SERP. The ranking neural network 34 can have passed testing when the outputs have absolute values which reflect the desired SERP order, as inferred from user activity. For example, if the user 12 activity is inferred to have produced a ‘312’ URL ranking within a SERP, then training can be complete when testing shows that the ranking neural network 34 produces, for example, the following output values: 4.3, 3.3, −5.3.

In general, training is complete for this particular SERP, so long as a first output is less than the absolute value of the third output and a second output is less than the absolute value of the first output. Overall training is complete when all training inputs produce correct outputs. It is expected that this approach to representing each URL as an output and to take the magnitude of the absolute value rather than just the positive or negative value of an output to represent rank can make training of the ranking neural network 34 quicker, as it can be less difficult for the ranking neural network 34 to learn to do the ranking with this extra degree of freedom. The Grabhat Cloud 30 then appropriately ranks the SERP as URLs, links and text abstracts for presentation to the user.

### Query Language Progressions (QLPs) and Suggested Alternate Queries (SAQs)

QLPs were first introduced in U.S. Pat. No. 8,346,753 granted Jan. 1, 2013. QLPs arise when a single user is unable to initially communicate what they are searching for to the search engine, but eventually, after some research, a user learns the correct language to use in a query, that produces a SERP which is relevant to the user.

The present system is designed to reduce a user's effort in discovering the correct language to use. In one instance of the present system, this is done is by identifying the beginning of a QLP and the ending of a QLP and storing the information for future use. In this case, the key information stored are the queries entered by the user. Future searchers, of similar profile, then can benefit from work done to resolve prior QLP episodes. The present system trains an ANN to indicate the beginning of a QLP by outputting the SAQ seen in past QLPs to have satisfied a user. If the user tries the SAQ and likes the resulting SERP, advantageously the user's time and effort has been saved.

The Grabhat Client 18 monitors user interaction with presented SERPs. The Grabhat Client 18 conveys this information, along with user query (voice or image), and user profile back to the Grabhat Cloud 30. The Grabhat Cloud 30 stores the series (two or more) searcher queries, along with the user's profile 16 as training sets for a recurrent ANN (RNN) (e.g., RNN 32). The final query issued by the user is used as an output to train the QLP RNN. A recurrent ANN can be used to deal with a variable number of queries issued, and the progression of query language across elapsed time, from one search session to the next. Thus, the task of the ANN is to indicate the beginning of a QLP by producing a SAQ. If the ANN has not seen a query from a particular profile corresponding to a QLP, then no SAQ is generated or provided back to the user 12 for consideration. Any time the same user issues two queries within a few seconds of each other, typically following minimal review of the SERP, the present system assumes a QLP has been initiated. Once a user reviews a resulting SERP and the system infers searcher judgment of relevance to their query, the system assumes a QLP has ended and the series of queries issued are packaged as a training set for the recurrent ANN. Time spent reviewing result abstracts within a particular SERP is used to decide if a QLP is occurring. Time between queries in a QLP is recorded and used as an input to the QLP RNN.

The following sections discuss software engineering details and software requirements for the Grabhat system of the present disclosure.

The Grabhat Cloud 30 can be executed on a cloud computing platform, such as Amazon Web Services (AWS), Azure, etc., while the Grabhat Client 18 can be executed on the user device 14. GrabHat preserves searcher privacy while personalizing search-based parameters on a searcher's profile. Each searcher self-selects their profile. Each searcher owns and controls access to their profile and shares it anonymously, with the GrabHat system, temporarily. The Grabhat system does not store the profile beyond time needed to process the search session and conduct training of ANNs. Personalization is done at the group or profile level, assuming more than one searcher shares the same profile with others. The GrabHat system does not associate any individual with any profile. The GrabHat system stores only the aggregate impact a profile type has on search result abstract ranking (generally referred to as ResultRank). The ranking of individual search results is updated incrementally, ANN training session by ANN training session, on a per profile type basis. The GrabHat system makes no effort to identify any individual or associate a profile or query with any individual. Steps are taken to prevent others from associating any individual with any profile or query. Users (e.g., searchers) own their profile. A user can delete, store, enable or disable their profile at will. The user is thus also in a position to control any “filter bubble” concerns.

The profile is designed to better identify the searcher's use of language. Searchers with similar profile characteristics are likely to share similar use of language. Even within the same language there exist distinct discourse (speech) communities. Each community shares a unique use of language, which is commonly understood and used within that community. The GrabHat system attempts to identify membership in such communities, based on profile. Searchers self-select their personal profile attributes or “hats”. The Grabhat system defines a plurality of hats which are believed can help to identify and delineate speech community membership. Searchers select from this standard list of hats to represent their profile. Profiles are attached to each query issued by each searcher. For example, if the user enters a textual query, then a combined string [query+profile] can be encrypted before transmission from the user device. In addition, the user device can use a high anonymity proxy server (or equivalent, re: Tor Browser) to hide any personally identifying information from the Grabhat system. The GrabHat system can use click-analysis of searcher interaction with the SERP. This allows automated inference of searcher relevance judgments (of search results) on a per profile basis.

The Grabhat system can be language independent. Searchers can be expected to enter no profile, a partial profile, or a complete profile. If a searcher does not enter at least a partial profile, they can receive SERPs which are not personalized based on profile. Regardless a best effort at personalizing SERPs and generating QLPs can still be made based only on the searcher's query. Searchers who provide a profile, can receive more personalized results. Searchers who do not provide a profile, may still benefit if their query language/image/audio can be correctly classified by the Ranking and QLP Artificial Neural Networks (ANNs). The query, by itself, may contain sufficient information to allow the ANN to do some personalization. Voice queries can contain more of such information than image-based queries, and that image-based queries can contain more such information than text-based queries. Voice queries constitute samples of a searcher's voice and as such can, in some situations act as a biometric which is personally identifying. The Grabhat system can encrypts all communication with the searcher and precludes the possibility of tracking by IP address through the use of proxy servers, or equivalent (re: Tor Browser). In addition, the Grabhat system can receive, process and temporarily hold the searcher's voice query in memory. The searcher's queries and any profile provided are used by the Ranking and QLP ANNs. After ANN training profiles are dropped from Grabhat storage. In this manner, unlike other search engines which rely on invasive tracking, the Grabhat system does not create or store personal data. In addition, the Grabhat system takes steps to minimize the time that query and profile data is stored for use as ANN training sets. These steps serve to minimize searcher exposure and increase the privacy of searchers.

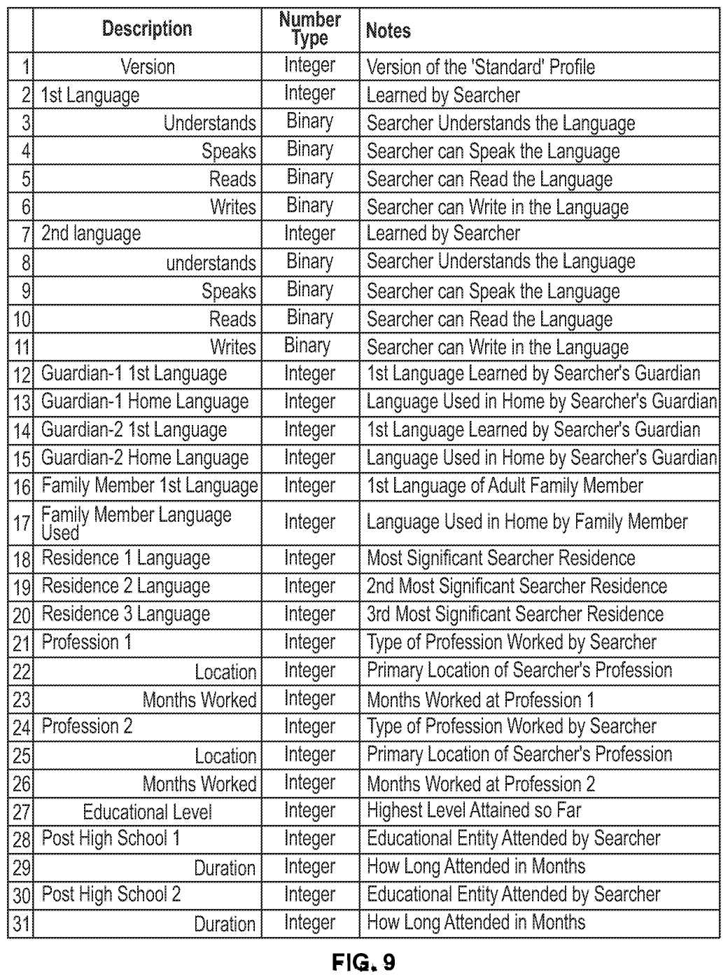

FIG. 9 is a table showing an example of language profile representations (e.g., hats) for input into the ANN. The ‘hats’ in the table of FIG. 9 is discussed in more detail below. Note that in the design of an ‘interview’ to be conducted with the searcher to obtain the profile, answers to the contents should be given preference, such that if the searcher grows weary of questions, the most important information can be taken first.

In an example, the top two languages used by the searcher can be collected. Each of the languages can be represented as an integer input to the ANN. The integer can be taken from assigning a numbered to the list of languages (using, for example, the URL http://www.muturzikin.com/languages.htm). This URL contains over 7000 languages listed in alphabetical order, cross-referenced by region/country. Based on this URL, a list can be prepared, numbered and stored. The numbered list can be used for each profile entry, as part of the GUI. The two integer inputs to the ANN can be constrained to represent the order in which the searcher learned the languages. For each language there can be four (4) additional binary ANN inputs. The four inputs can indicate if the searcher: 1) understands, 2) speaks, 3) reads, and can 4) write in a particular language. Language use by family members in a searcher's home is also collected. Of interest is the first language spoken by the searcher's adult family members, such as parents, grandparents, aunt, uncle, etc.; who were in the home while the searcher is/was living at home. Also of interest is the primary language actually used by the adult family members in the home while the searcher is/was present. Pre-school period of development before 5 years of age is most important, declining in importance following puberty. The first language and the language used at home, by two parents and one extended adult family member can be collected. Each adult family member's first language and home language used, is mapped to two ANN integer inputs, using the list from the above URL. Thus this category will require a total of 16 ANN inputs. Six (6) of the ANN inputs can be integers (max of 2 for the searcher and 2 for each of the 3 adult family members) and 8 can be binary ANN inputs (4 for each of a max of 2 languages used by the searcher).

The ‘franca lingua’ of an area the searcher has spent time in is expected to influence their speech community. The Grabhat system can record multiple locations lived (for example, three locations where time spent there was more than 6 months). If a searcher has more than 3 residences sites, use the three where the most time was spent can be used, earliest in a searcher's life. Pre-school period of development before 5 years of age is most important, declining in importance following puberty. Residence locations after the searcher age of adulthood are important; but given less significance than are residence locations during the developmental years. The locations can be recorded as latitude and longitude and selected by the user on a map by pointing and clicking. The chronological order of the locations can be mapped to specific ANN inputs.

The latitude/longitude selected by the searcher can be automatically mapped to the Geo-location place names (as cross-referenced to language) in the following URL: http://www.muturzikin.com/languages.htm. The precision of the latitude/longitude can be adjusted as required to preserve privacy. For example, if the latitude/longitude indicates a particular home, this can be made less precise and shifted out to perhaps a zip code area, or city. This can perhaps be done more simply by converting the DMS format to decimal format. Rounding to the nearest minute or ten minutes might suffice.

The same numbered list (as prepared above for languages spoken) is also used to indicate residence locations. As a result, the inputs to the ANN are integers. There are a total of three ANN integer inputs used to represent this category

A searcher's type of work and work place can be expected to influence their use of language. The link below lists several professions in multiple languages. From this site a numbered list of professions can be prepared. The numbers represent an individual profession. The searcher can be asked to identify (pick) a maximum of 2 work professions, if they were worked for a minimum of one year. The professions can be mapped to the ANN in chronological order, as profession/location/duration sets. This category can be mapped to a total of six (6) NN integer inputs, one for each profession, one for each location worked, and one for number of months worked at each profession/location. The numbered language/location list described above can be used to represent the location worked.

A searcher's education can be expected to influence their speech community membership. The searcher can be asked to indicate the highest level attained so far in their lives. The education level can map to a single integer ANN input with grade 1-12, BS=16, MS=18, PhD=20. The searcher can also be asked to identify any school, beyond secondary school, attended for at least one (1) year. A snapshot of the list of schools on the URL (https://en.wikipedia.org/wiki/Lists_of_universities_and_colleges_by_country) can be numbered and each school can be represented by its integer number as an input to an ANN. The number of months attended will be an integer input to an ANN. The searcher can be asked to enter a maximum of two (2) schools (post high school) attended in chronological order. The searcher should choose the schools attended for the longest duration of time.

This category can map to a total of 5 integer ANN inputs—one input for the educational level attained, two inputs for a maximum of two post-high schools attended, and two inputs for duration of attendance at same.

The profile collection GUI can be determined during the design and coding phase and can be documented in this section of the SRS in mutually agreeable format. Some searchers may enter only partial profiles. Integer inputs that are not applicable or not entered can be supplied a constant zero (0) value for ANN training. Binary inputs which are not used/applicable can be supplied a value of 0.5 (halfway between a 0 and a 1). Based on results obtained from testing and actual use, the system may simplify the profile to what are currently deemed to be the more (most?) significant hats. There is a trade-off between ANN training time and the amount of detail in the training inputs. The more detailed the training inputs to the ANN the longer the task of training takes, the more resources required.

The profile can be encrypted before storage, as well as password protected on the searcher's device. The password used to decrypt the searcher's profile can also serve to effectively log the profiled searcher into Grabhat. A password can only be used if the searcher has at least entered a partial profile.

The searcher can have the option of speaking their query, typing, or otherwise entering their query in text or image form. Assuming the foreign search engine is an entity separate from the Grabhat Cloud 30 (and communication between the Grabhat Client 18 and the foreign search engine can be encrypted) and in the event a searcher enters a textual query, in order to minimize turn time, the Grabhat Client 18 may send the text directly to the foreign search engine for generation of a SERP; assuming the foreign search engine can be controlled to allow the corresponding SERP to be returned not to the Grabhat Client 18, but to the Grabhat Cloud 30, for potential re-ranking before sending it to the Grabhat Client 18 for presentation to the searcher. This may also be done if the searcher enters the query as an image or voice, assuming the Grabhat Client 18 has the ability to convert the image or voice to a textual form—for use by the foreign search engine.

It the searcher chooses to enter an image query an attempt can be made generate text from the image on the searcher's device, such as using OCR. If this succeeds the resulting text can be routed to the foreign search engine (if a separate entity). Both the text and the image can be bundled with the profile and sent to the Grabhat Cloud 30 for further processing. In the event the searcher choses to enter a voice query, an attempt can be made to convert the voice to text on the searcher's device. If text of sufficient quality is obtained by the Grabhat Client 18, it can be sent directly to the foreign search engine (assuming the foreign search engine is separate from Grabhat Cloud 30). The text and voice query can be bundled with the profile and sent to the Grabhat Cloud 30 for further processing.

All communication between the Client 18 and the Cloud 30 is encrypted. Before sending any Query Combo to the Cloud it can be encrypted. Query Combo's consist of the different forms of query combined with the searcher's profile (if available). It may be found to be desirable to make separate transmissions, for the profile and portions of the query. Upon receipt of the SERP from the Cloud it can be decrypted and parsed into individual result abstracts for display to the searcher. The SERP can be sent in ‘chunks’ of a maximum of 5 results at a time. If the searcher desires more results, a ‘more’ option (or just scroll down) can be offered to the searcher. If the searcher selects the more option, than an additional 5 result abstracts can be requested from the Cloud, received, processed and presented.

### Searcher Interaction Events

Events of interest include the following:
1) Mouse pointer location and movement (when the SERP is in focus and in relation to the presented result abstracts—time spend hovering over each result abstract)
2) Searcher click-thru on a result abstract.
3) Dwell time on the clicked search abstract.
4) When a searcher returns focus to the SERP following review of a result abstract.
5) When the searcher ends the search session.

### Event Times to Record

The following steps are implemented:
1) Record the time a SERP is first presented to a searcher.
2) Record times (relative to presentation time) spent hovering, start and stop, over each result abstract.
3) Record time of any click-through on a result abstract.
4) Record time focus is returned to the SERP following a click through.
5) Record time the search session ends.

### End of Search Session

It's assumed the search session has ended when the searcher does one of the following:
1) Closes the Grabhat Client.
2) Removes focus from the Grabhat Client (i.e. SERP focus) or is completely inactive (with respect to the searcher device); for more than one minute.
3) Enters a new query.
4) Selects the SAQ.

The decision or inference, as to whether, or not the searcher re-ranked the Gigablast SERP during the search session can be determined as much as possible, locally by the Client 18. The Client 18 determination can then be communicated back to the cloud as described below.

In the case that the foreign search engine (Gigablast) has search abstract order of 1, 2, 3, 4, 5; for example, and if there is a local determination/inference that the searcher has re-ranked the SERP, placing the 3 abstract as more relevant than the first abstract, perhaps by clicking on the 3^{rd} abstract in an out-of-order manner, then the Grabhat client 18 can convey this by sending back a representation of the ordering: 3, 1, 2, 4, 5.

Even though the system initially limits the SERP ResultRank reporting to the top 5 results, searcher choices deeper into the SERP are still reported. For example, should the searcher select the ‘More’ button/tab, or just scroll down beyond the top 5 result abstracts presented, and execute an out-of-order click-through on say the 11^{th}, result abstract, then the Client might convey 11, 1, 2, 3, 5 as the ResultRank, back to the Cloud.

If the searcher returns focus to the SERP following an ‘end-of-session’ decision and interacts further with a SERP, it can be treated as a new search session.

The method of inferring a searcher re-rank follows. If the first searcher click-through on a result abstract is not the highest ranked result abstract in the SERP, this click-through can be considered an ‘out of order click-through. If subsequent result abstract click-throughs, are not in the order presented they are also considered out-of-order click-throughs. The order of click-through becomes the new SERP inferred ranking, provided searcher satisfaction can be inferred by the Client. Dwell time on each abstract clicked on is used as a measure of satisfaction, particularly if the searcher ends the search session immediately after reviewing an abstract. It is assumed that the longer a searcher dwells on an abstract, then ends the session (unless the session is ended by selecting the SAQ); then the greater the satisfaction. A minimum of 5 second dwell time can be required for inferring searcher satisfaction with a result abstract.

If the searcher does multiple click-throughs, regardless of result abstract dwell times, an inference of satisfaction with any given abstract is more doubtful. However, in this case the Client can still forward the click-through order back to the Cloud. If for example, the searcher ‘immediately’ enters a new query, following a search session and/or clicks on the SAQ, then the Cloud may decide not to use the Client communicated ResultRank for training the Ranking ANN, but instead, conclude the searcher has initiated a QLP.

The Cloud 30 may access any additional detailed event data on searcher interaction with a previously presented SERP. Initially only the click-through order and total search session elapsed time can be returned to the cloud. The system can determine how long to store detailed event data on the Client Device following the end of a search session. If the searcher enters several queries, one after the other, close in time and/or selects the SAQ, a QLP may have been initiated. In which case it may be found that access to a previous search session's detailed event data is helpful to the Cloud's SAQ generation task. In the absence of a possible QLP being initiated, all event data can be dropped immediately. If the detailed event data is stored, it can be encrypted prior to storage and saved only as long as the Grabhat client is running, or the end of the QLP is detected; whichever comes first. The end of a QLP can be detected if no further queries are entered for a maximum period of 1 minute of inactivity following the end of the latest search session. Events can be appended to the profile and forwarded to the cloud, following encryption.

SAQ Language can be continuously presented following each query. The searcher's selection of the SAQ can also be taken as an indication that the searcher needs assistance with determining the correct query language for their area of interest. This is a definite indication that the searcher has initiated a QLP and/or may be multiple queries into a QLP. This information is expected to be helpful in training the QLP/SAQ ANN in the Cloud. Initially, the system may not have sufficient training data, to generate meaningful SAQs. In such a case, the system can offer the top ranked result abstract from the SERP provided by the foreign search engine, instead of suggested alternate query language in the SAQ field. It's expected that the Grabhat system's ability to personalize (re-rank) a foreign search engine SERP can improve prior to the Grabhat system's ability to generate meaningful SAQs. As the Grabhat system's ability to personalize matures, for a period of time, the system may find it useful to continue to offer the foreign search engine SERP, while offering Grabhat's top re-ranked search result in the SAQ field. This can allow the searcher to see the foreign search engine SERP verbatim, while also seeing Grabhat's assessment of the most relevant result abstract in the SERP. It's expected that as searcher confidence in Grabhat's personalization increases, the frequency of searcher selection of the SAQ field offering can increase. This information may be helpful in deciding when to switch from offering the foreign search engine SERP to offering the Grabhat personalized SERP instead.

For anonymity, a Tor Browser can be used. A concern with the use of Tor is the time it takes for a Query Combination [query+profile] to be transmitted to Grabhat Cloud and for the Cloud to respond with a SERP. Likewise, the time it takes to transmit SAQ's from the Cloud to the Client is a concern. Thus it can be optional, depending on selection and use by the searcher.

The system supports three different types of query entry: typed text, an image of a query and a verbally spoken query. The system assumes a typical searcher can enter only one form of the query (e.g. text, image, or voice). Some users can enter a profile and others may not. Each of these scenarios is considered below. The Cloud can have the responsibility of making sure all three forms of query are available for use, as required. As such the missing queries and/or profile can be generated for use as inputs to the Ranking and QLP ANNs. In addition, the Cloud may need to temporarily store the queries, the profile, and the SERP for use in training the ANNs. The length of time to store can be determine by the system or user. Storage can be required until ANN training is completed. Training can be be done in batch form, after several training sets have been collected, particularly through beta testing. Once the system attracts more searchers training can be on-the-fly, immediately discarding training sets following a search session or QLP. Initially, the number of query/profile/SERP/ResultRank sets to be stored is and can be dependent on the number of searchers using Grabhat and other trade-offs involving privacy, execution time, cost, and how well the planned use of generational training works.

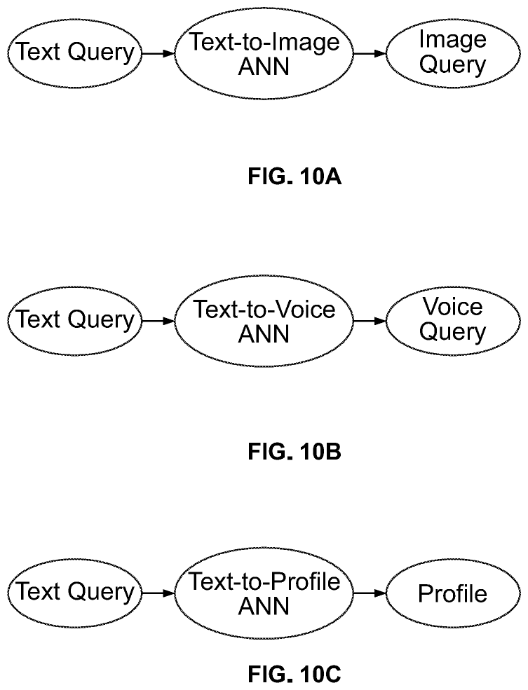

The Grabhat Client can send a textual query directly to the foreign search engine. This is expected to save time if the foreign search engine can be made to return the resulting SERP to Grabhat Cloud (instead of Client). If not, then the text query is sent to the foreign search engine by Grabhat Cloud. In this scenario, the searcher has not entered a profile and chosen to enter a text query. This is the least amount of information the system can expect to work with. In this case, the system is tasked with generation of an image and voice query; as well as a profile. The system first uses the text query to generate an image query. This can be done with the previously trained ANN shown in FIG. 10A. The system then uses the text query to generate a voice query with the pre-trained ANN shown in FIG. 10B. The system then uses the text query to generate a temporary session profile as shown in FIG. 10C. Note that the ANNs taking only a text query as input are pre-trained using training sets from scenarios when image queries, voice queries, and profiles were provided. The generated queries and profile are used as inputs to the Ranking ANN and the QLP ANN. Since they are not used for training, they are not stored beyond the time required to use these ANNs for the associated search session and/or QLP.

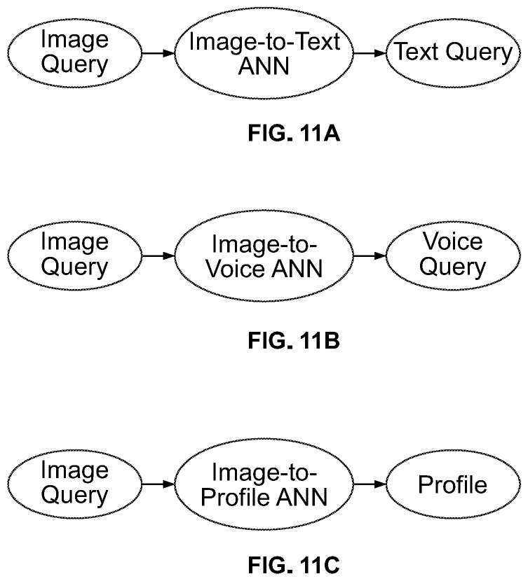

In another scenario, the searcher has not entered a profile and chosen to enter an image query. The image query may offer more useful information than the text query. In this case the system is again tasked with generation of a best guess session profile, the text query, and the voice query. The system first uses the pre-trained ANNs shown in FIGS. 11A and 11B. Next, the system uses the pre-trained ANN shown in FIG. 11C to generate a temporary, best guess, session profile. The image query, the generated voice and text queries and the generated session profile can then be used as inputs to the Ranking ANN and the QLP ANN. In addition, the system use the searcher entered image query and the generated text query to train the ANN in shown in FIG. 9A. The image query is used as a target output of this ANN and the generated text query is the input. Use of an actual searcher entered image is expected over time to allow this ANN to produce better images from text queries.

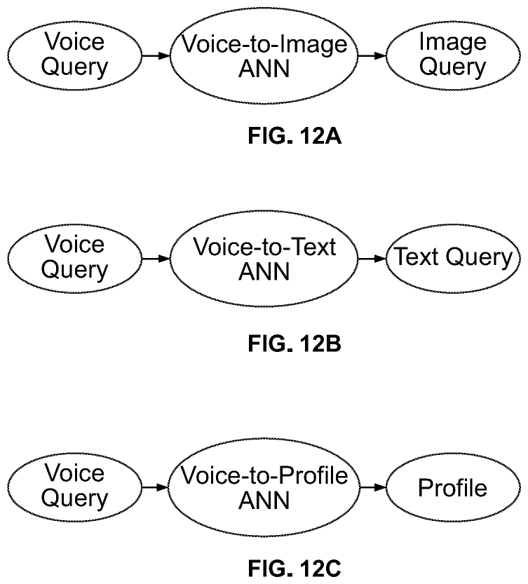

The following is a scenario when the searcher enters a voice query. The searcher entry of a voice query offers more information than does entry of a text or image query, from a Grabhat language interpretation perspective. In this case, the system uses the ANN shown in FIG. 12A to generate an image query from the voice query. Next the system uses the entered voice query to generate a text query, as shown in FIG. 12B. The system then uses the voice query to generate a temporary session profile using the ANN, as shown in FIG. 12C.

The system now has a searcher enter voice query and generated profile, text query, and image query which are used as inputs to the Ranking ANN and to the QLP ANN. In addition, the searcher entered voice query is used as a target output, along with the generated text and image queries, to train the ANNs. This improves the ability of these ANNs to generate a realistic voice query in future use.

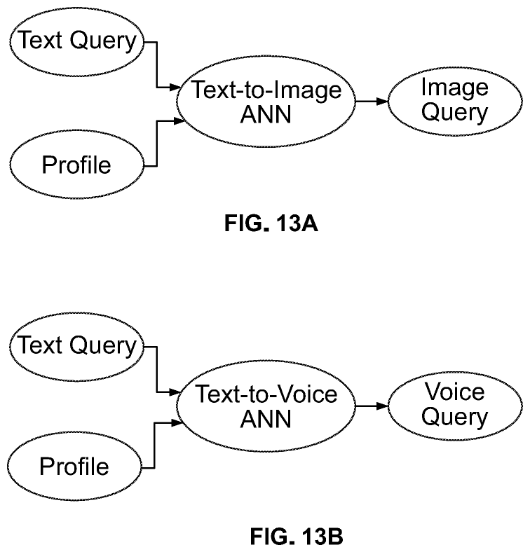

In this scenario, the searcher entered a profile and a text query. The system uses the profile and text query to generate an image query, and a voice query as shown in FIGS. 13A and 13B. The searcher entered profile and text query; and the generated image and voice queries can now be used as inputs to the Ranking ANN and the QLP ANN. The existence of a searcher entered profile increases the probability that the generated (image) query can contain more useful information (for personalization) than a similar query generated without a profile being available. In general, the system seek to train an ANN with training sets, which contain more information than the input(s) that the particular ANN can be used with. Thus, the actual searcher entries that include a searcher entered profile are useful in training the ANNs that operate without a profile input. Also, the searcher queries from a profiled searcher are useful in training the profile generating ANNs. As such, the system can use the searcher entered text query, as input and the generated image query and the generated voice query as target outputs, to train the ANNs shown in FIGS. 9A and 9B. The system can use the generated image as input, and the searcher entered text and the generated voice as desired target outputs to train the ANNs shown in FIGS. 10A and 10B, respectively. The system can use the generated voice query as input, and the generated image query and the searcher entered text query as desired target outputs to train the ANNs shown in FIGS. 11A and 11B. In addition, the system can use the searcher's profile as a desired target output, and the searcher entered text query, the generated image query and the generated voice query, to train the ANNs discussed above.

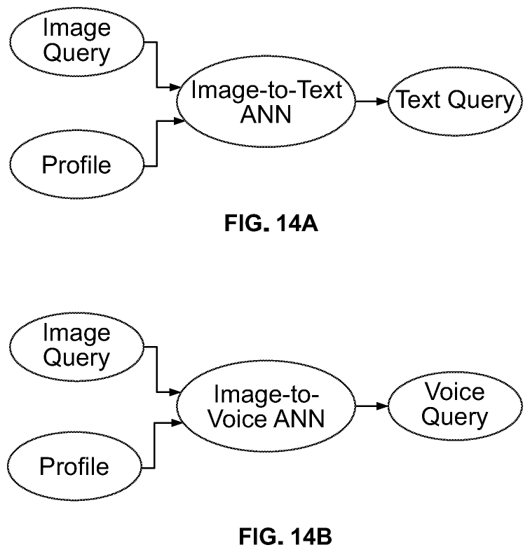

In this scenario, the searcher entered a profile and chose to enter an image query. The system can use the entered information, in combination with pre-trained ANNs to generate the balance of information needed by the Ranking ANN and the QLP Ann. In addition, the system can use the entered information to train all the ANNs used to generate missing information when a profile has not been provided. The system use the entered image query and profile to generate the text query as shown in the ANN in FIG. 14A. The system uses the entered image query and profile to generate the voice query as shown in the ANN above. The system now has a profile, text, image, and voice queries for use with the Ranking and QLP ANNs. The system then uses the generated text query, the searcher entered image query, and the generated voice query as inputs and target outputs to train the ANNs, as discussed above. The system then uses the searcher entered profile as a desired target output, and the generated text query, the searcher entered image, and the generated voice query as training inputs to the ANNs. In addition, since in general an image query can contain more information that a text query, the system uses the searcher's profile, and the generated text query as inputs; along with the searcher entered image query as a desired target output, to train the ANN.

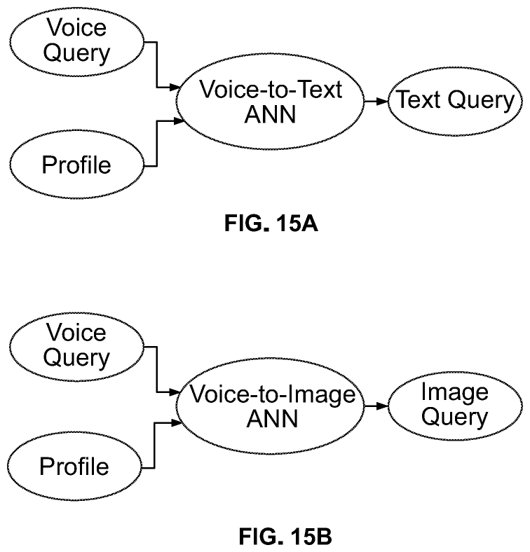

In this scenario, a searcher has entered a profile and a voice query. The system uses the ANNs shown in FIGS. 15A-15B. The system now has searcher profile, and text, image, and voice queries which can be used with the Ranking ANN to personalize a SERP and the QLP ANN for generation of a SAQ. The system uses this relatively high information content of a searcher provided voice query and profile to generate text and image queries as described above. The system then uses the profile and queries (entered and generated), as required, to train the ANNs.

The foreign search engine SERP can be based on a textual query. The foreign SERP can be directed to Grabhat Cloud for use as input to the Ranking ANN. The Ranking ANN can make use of the top five or so ranked URLs. The output of the Ranking ANN may be a new ranking order for these top URLs. The potentially re-ranked SERP can then be sent to the Client for presentation to the searcher.

The ResultRank received from Grabhat Client is the result of monitoring searcher interaction with the SERP presented. ResultRank is typically received at end of a search session. ResultRank is used in conjunction with the searcher profile, query, SERP presented to the searcher; to train the Ranking ANN. The system can personalize SERPs for all users, whether they enter a profile or not, regardless of the type of query they enter, and regardless of their interaction with a SERP and/or use of the SAQ. Representation of URL's for Search Result Abstracts can use the underlying IP address. A unique addition indicating the balance of the URL (i.e. file/path names, extensions, etc) may be necessary. In the preferred embodiment there are two inputs to the ANN, one binary input to indicate either IpV4 (0), or Ipv6 (1); another integer input indicating the decimal equivalent to the IP address. It's understood that the IP address cannot uniquely identify/locate result abstracts, but it is likely sufficient for our purpose of ranking URLs.

Regardless of the language a searcher may enter a query with a keyboard, or by voice; for example. Entry of the query by spoken voice is best (higher information content), as it contains the most information about how the searcher uses language. Such things as speech rhythm, pauses, inflection, intonation, volume, and accent are captured. When the searcher enters the query using a keyboard, for example, to type characters, there is not as much information conveyed; as conveyed by voice or even hand-written queries. The information content of handwritten text is higher as it contains a searcher's unique style. The Grabhat system can capture and utilize the following: Voice queries, Image queries (These can be images of hand-written queries (via pencil, paint brush, stylus, mouse or other pointing device, etc.). The system can first attempt character recognition of any text in the image. If this fails, or the picture/image provided as a query is a picture which contains no text. In this case Grabhat can make a best effort at generation query text for the image. The searcher may also be given the opportunity to tag the image, via keyboard or voice), keyboard typed queries, to preserve and use as much of the information the searcher entered as possible (It is assumed that foreign search engines convert typed text to numbers associated with ASCII characters).

The Grabhat system can be capable of converting to and from the above three types of searcher queries. This can be accomplished using voice to text and text to voice ANNs, text to image and image to text routines; depending on the type of query entered by the searcher.

Use of an image of the query takes advantage of the recent ‘deep learning’ advances of convolutional neural networks (CNNs). Similar queries (entered by similarly profiled searchers) are likely to contain portions which are visually identical; and/or which look similar to each other and which may contain clues as to a searcher's speech community membership. An advantage of this approach is that it allows use of the same ANN structure and training sessions (number of inputs, layers, and connection strategy) to handle multiple searcher languages. At least initially all image queries (containing text) can be treated as gray scale images, in order to simplify training of the NNs.

The system can store a text version of the query in the database. If the searcher generates an image query or a voice query the system can use the text query generated from either of these. The system can store the entire text query in the database. Alternatively, the system can store a hash of the query. This may be helpful because the query hash is smaller (less training demands on the ANN) and privacy is better preserved.

Training is exacerbated because one has nothing in common with a hash resulting from a similar profile. Exact hash matches from different searchers, entering queries at different times, are unlikely, even if similarly profiled. Alternatively, the system can store the SAQ that the query is associated with. This may be helpful assuming many queries map to the same SAQ and presumably the SAQ produces a better SERP. The SAQ may also have the advantage of being smaller than several of the queries that map to it. In addition, this approach has the advantage of allowing the searcher's query to be thrown away, thus further preserving privacy. It is likely advantageous to map all queries to the same font, to allow matches between searchers with the same speech community, but using different fonts. The system can store the query in the database.

It can be advantageous to represent each result abstract URL by its corresponding IP address, even if this does not map unambiguously, to the relevant content. The system is not tasking the ANN with mapping to the exact content in the result abstract only in ordering the subset of result abstracts considered. The system can store the IP address of the top 5 result abstracts in order in the database as IP addresses.

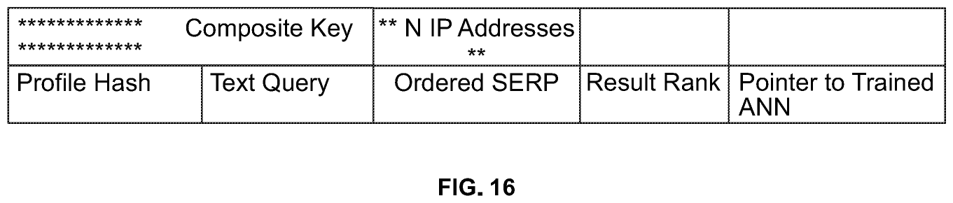

The above described training sets are used to train ANN(s). Once the ANNs are trained the above inputs, output, and trained ANN, are stored in training set databases. A pointer to the ANN trained with the patterns is another entry in a database record, as shown by way of example in FIG. 16. Storing the pre-trained ANN (trained with a ‘generation’ of training patterns) allows the training patterns to be disassociated with the profile (via one-wah hash of profile) to preserve searcher privacy. A preferred way to store the data in a database is to use the profile hash as half of a composite key to the records in a database. The primary key for the records in the database is a composite of the profile hash and the text query.

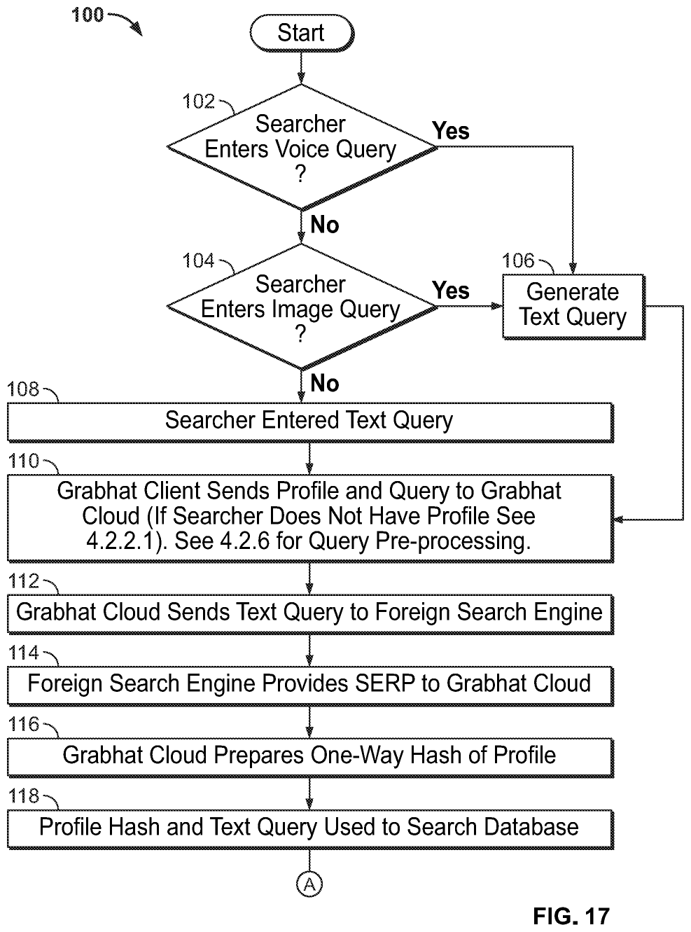

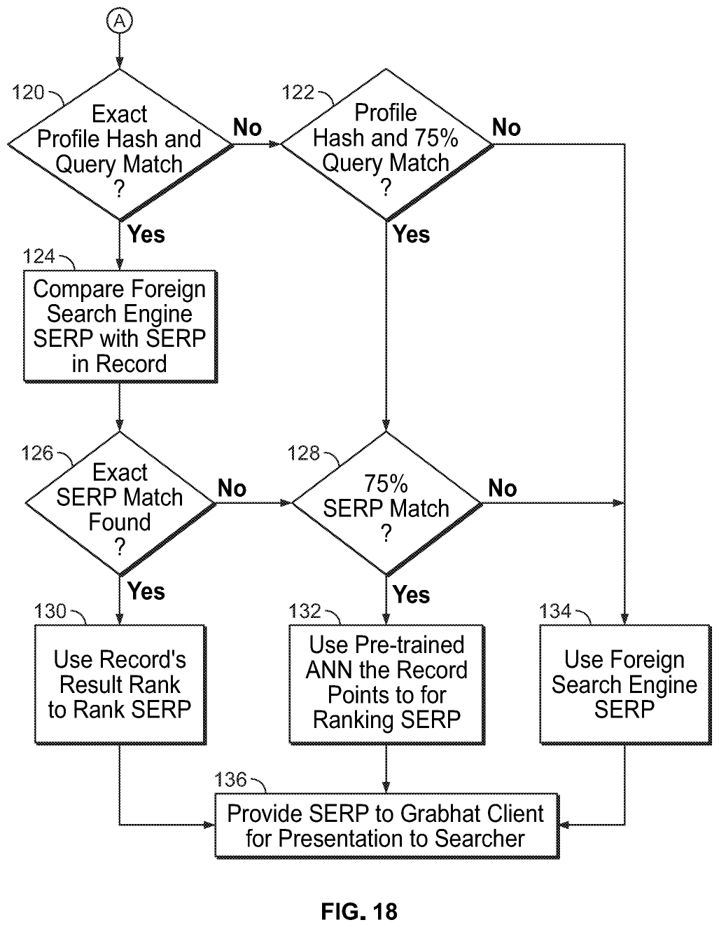

FIG. 17 is a flowchart showing a method for processing of searcher data for SERP ranking, indicated generally at 100. In step 102, the system determines if the searcher entered a voice query. If no, the system proceeds to step 104, where the system determines if the searcher entered an image query. If yes for either step 102 or 104, the system proceeds to step 106, where the system generates a text query, and then proceeds to step 110. If no in step 104, the system proceeds to step 108, where the searcher enters a text query. In step 110, the Grabhat client sends a profile and a query to the Grabhat cloud. In step 112, the Grabhat clout sends text query to a foreign search engine. In step 114, the foreign search engine provides SEPT to the Grabhat cloud. In step 116, the Grabhat cloud prepares a one-way has of profile. In step 118, the system uses the profile hash and the text query to search a database. Method 100 continues in FIG. 18.

In step 120 of FIG. 18, the system determines whether the exact profile has and query match, if no, the system proceeds to step 122, where the system determines if the profile has and 75% of the query match. If yes to step 120, the system proceeds to step 124, where the system compares foreign search engine SERP with SERP in record. In step 126, the system determines if an exact SERP match is found. If yes, the system proceeds to step 130, where the system uses record's ResultRank to rank SERP. In step 136, the system provides SERP to Grabhat client for presentation to the searcher. Returning to step 122, if not a match, the system proceeds to step 134, where the system uses foreign search engine SERP. If yes to step 122, the system proceeds to step 128, where the system determines if a 75% SERP match exists. If no, the system proceeds to step 134. If yes, the system proceeds to step 132, where the system uses a pre-trained ANN to record points for ranking the SERP.

Near the beginning of this process, the SERP is returned from the foreign search engine. The profile and the query are available, but the SERP has not yet been presented to the searcher. At this point, the profile's one-way hash is calculated (see discussion in 4.2.5.5) and a text query is obtained if the searcher entered a voice or image query. A search of the database is done using the profile hash and the text query. If a record is located which matches the entire composite key exactly, then the SERP from the foreign search engine is compared with the SERP in the record found. If the foreign search engine SERP is an exact match to the SERP URLs in the query, then the ResultRank in the record is used to rank the SERP for presentation to the searcher.

If at least 75% of the SERP matches (e.g. IP addresses match without regard to order) then the pre-trained ANN pointed to in the record is used to generate an order for the SERP. If less than 75% of the SERP matches, then the foreign search engine is presented to the searcher, as is, without re-ranking. In general, the SERP contains an arbitrary number (N) of URLs (represented as just their IP address). However, at least initially, the system can limit this to the top 5 entries in the SERP. If the hashed profile matches, but the query is not an exact match, then a search for the best matching query, with matching profile hashes is conducted. Once the best match is found (e.g. profile hash has exact match and query has at least a 75% match, then the SERP from the record is compared with the foreign search engine SERP. If the SERP URLs are at least a 75% match (without regard to order) then the ANN pointed to by the record is used to generate a ResultRank which is used to rank the SERP for presentation to the searcher. It is understood that the ‘75%’ matching level is adjustable. Depending on results obtained, these levels may be adjusted over time or use. Initially, given the use of 5 URLs from the SERP the system can look for at least a ⅗ match of query and SERP.

The approach is to replace the aforementioned Ranking ANN with multiple generations of partially trained ANNs. This minimizes the need to store training patterns which might contain sensitive information. The system trains the Gen-1 ANN with Gen-1 patterns, then freeze the Gen-1 ANN weights and throw the Gen-1 patterns away. Throw each generation of training patterns away after training the corresponding Gen ANN. Continue to apply all subsequent pattern sets to the Gen-1 ANN, the Gen-2 ANN, the Gen-3 . . . , Gen-N-1, all the way up to the current Gen-N ANN. Take the outputs from all previous generation ANNs (Gen-1 through Gen-N-1) and add them to the corresponding Gen-N outputs. The error signal after each training cycle is thus the difference between the Gen-N desired target output, summed with the corresponding average actual outputs of the Gen-1 through Gen-N-1 and the desired target output associated with the particular pattern, in the Gen-N training set. Error signal for training=actual [Gen1ANN Output+Gen2 ANN Output+ . . . +GenN ANN Output]/N−desired output (for training).

Training is conducted with the Gen-N pattern set, while only adjusting the weights to the Gen-N ANN, with all prior ANN weight sets frozen; but incorporating the output of all prior generation ANNs. Thus, each generation of ANN retains the ability to react well to the pattern set it was trained with and each of the subsequent generation ANNs are forced to ‘fix’ any errors introduced by a lack of generalization to previously unseen patterns. The combined ‘wisdom’, so-to-speak, of all the previous generations can be used, for better or worse. It is expected that the error signal can get smaller and smaller as the number of generations grows, using this ANN ‘ganging” algorithm. There is a chance that ‘contradictions’ can be encountered. These would be training patterns that contradict each other.

For example, if an ANN has a single binary value output and there are two training patterns that have the same input values, but opposite output values. These would be contradicting patterns. An ANN cannot learn to correctly classify both patterns and so an oscillation of sorts happens. In our case, to be a complete contradiction, this might be an exact opposite ranking of the top 5 result abstracts in a SERP, but with identical inputs. This is often an indication of a lack of detail in the inputs. In our case a contradiction would be perhaps due to a lack of detail in the profile. Perhaps additional profile details would differentiate the inputs and thus allow the ANN to properly classify both training patterns. This might also be an indication of an attempt to game the system.

The current Gen-N ANN learns how to correctly classify the current Gen-N training patterns, while also adjusting to any error introduced from ALL prior Gen-1 through Gen-N-1 ANN outputs, in the presence of potentially, previously unseen patterns in the Gen-N pattern set. If the Gen-1 through Gen N-1 ANNs have sufficiently solved the problem, they can generalize and correctly order the outputs in the presence of previously unseen patterns (in Gen-N). If not, then it becomes the task of the Gen-N ANN weights to solve this lack of generalization problem. Each generation of ANN weights can be thought of as adding a layer of weights to fix any error produced from previously unseen pattern sets. It is desirable to keep the number of weights in each generation of ANN to a minimum needed and thus minimize training time. It is also desirable to minimize the number of training patterns (one pattern generated per search session) in each generation, so as to allow discard of training sets quickly.

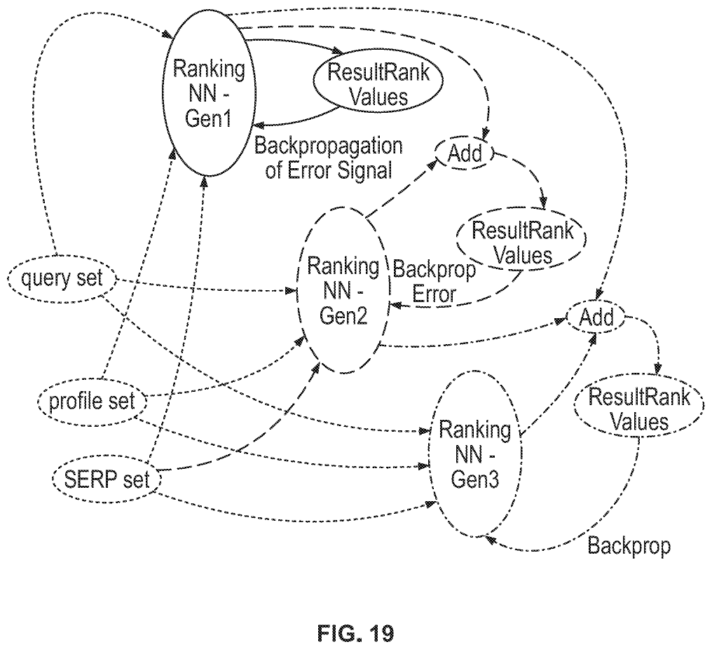

FIG. 19 is an illustration showing a generational training, ranking ANN. The training inputs for the Ranking ANN are: Query, Profile, and SERP. Training outputs are: ResultRank. The result rank is mapped to a number of outputs of each generation of Ranking ANN. Initially the system limits consideration to only the top 5 ranked result abstracts in the SERP. This can map to 5 outputs of the ANN. During training each ordered output can map to an integer value. However, the system can score training success, during ANN testing, if the five outputs have values that are in the correct order, negative values are acceptable as long as the order is correct. For example, if the ResultRank is: 11, 1, 2, 3, 4.

This means the 11^{th} result abstract in the foreign search engine's SERP, or rather the associated IP address (which is also an input to the ANN), is to get the highest rank at the output of the ANN during training. As the system deals with only the top 5 result abstracts the system can use, for example, the integer 5 as a desired training output and not the integer 11, to train an ANN's output. This can keep the training of ANN outputs consistent regardless of how far the searcher delves into the SERP to click-through. This maintains a consistent target separation of one integer value between the outputs during training. This is necessary, in order to conduct the generational training and addition of multiple ANN outputs. During normal non-training operation, the outputs of the ANN must consider (map to) not the top 5 result abstracts in the foreign search engine SERP, but instead the top 5 result abstracts identified by the Client, or rather their IP addresses stored in Table 2—Sample Training Database Record. This makes it necessary for the Cloud to have the capability to map (search for and match), during the search session down perhaps as far as the searcher scrolled into the foreign SERP, or at least as far as the searcher did an out-of-order click-through on a result abstract—in order to get the correct IP address to store in the table. Then later during normal operation, when comparing SERPs stored in the table with URLs in the foreign search engine SERPs, comparisons below the top five results may in some cases be necessary. As another example, for clarity, suppose that the searcher clicks-through (in an out of order manner) on the 11^{th} and then the 15^{th} result abstract presented. This can result in a ResultRank of 11, 15, 1, 2, 3. Thus the 4^{th} and 5^{th} result abstracts have been knocked out of the top 5. Back at the Grabhat Cloud the IP addresses associated with the 11^{th} and 15^{th} result abstract URLs can be stored in Table 2, and used as inputs to each of the generational ANNs being trained. These 5 URLs correspond to the 5 outputs of each ANN. For this training pattern set, the target output values can exclude 11, 15, 1, 2, 3; but instead can be 5, 4, 1, 2, 3.

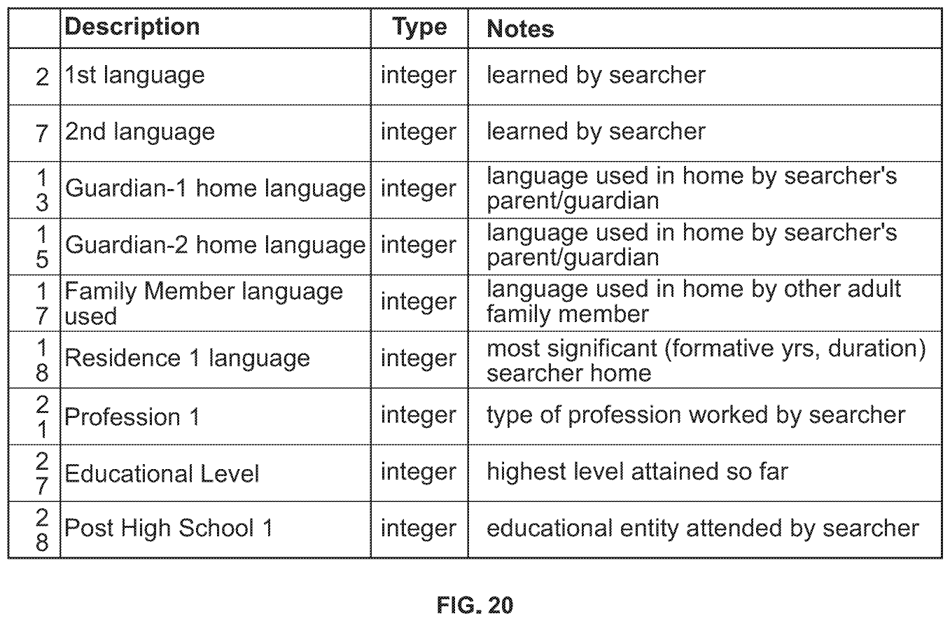

A one-way hash of the Profile is prepared. The hash prepared may be done across a subset of the profile collected. Using a subset of the profile shown in Table 1—Language Profile Representation for input to ANN can increase the probability of obtaining profile matches. During design & testing, the system can use a reduced size profile (smaller than the profile collected), for one-way hashing, and for training/use of ANNs. This can allow more ‘exact’ matches to the database key to be made. See the simplified profile shown in Table 3—Simplified Profile To Increase One-Way Hash Matches. FIG. 20 is a simplified profile to increase one-way hash matches.

There is a tradeoff between how many training sets are stored and how many generations of pre-trained ANNs are used per training session. Each generation only one ANN is trained, while the ‘ancestor’ ANNs are frozen (not re-trained) and their output is used only to produce an input to train the latest ANN generation. In FIG. 19, an example of 3 generations is shown. The red font illustrates the first generation of training. Once the gen-1 training set has been used to train the red gen-1 ANN, its weights are frozen and not trained further. Future training sets are applied to the gen-1 inputs, but the gen-1 output is only used to train the gen-2 ANN; during training of the gen-2 ANN. Once the gen-2 ANN weights are frozen, then the outputs of the gen-1 and gen-2 ANNs are used as inputs to train the gen-3 ANN. The system can determine how many ‘ancestor’ generations feeding outputs forward, to a current generation being trained can be useful. In other words, it may be found that there is some maximum number of pre-trained ‘ancestor’ ANNs generating inputs to the current generation ANN (being trained) that is useful/necessary. If during design, coding and testing, it is found that, for example, 100 such ancestor generations is that maximum number of useful pre-trained ANNs; then the oldest pre-trained ANN would be dropped. This may be that after 100 generations, the older training sets used for gen-1 are no longer useful; or it may be due to the fact that this information is now sufficiently built into or embedded in the weights of the next 99 pretrained ANNs.

It is likely that training sets used to train in one generation can be required for additional training in subsequent generations. Waibel took a somewhat similar approach circa 1990 in identifying sub-tasks, training smaller ANNs to perform these subtasks, then ‘gluing’ the ANNs together to perform a larger task. Waibel found that training time could be significantly reduced while maintaining performance. For example, see “Consonant Recognition by Modular Construction of Large Phonemic Time-Delay Neural Networks”.

The system can determine how many training patterns to collect and store for a training generation can be optimal, in terms of the trade-off between privacy and efficiency. This technique is intended to capture or transfer raw training set information, into a form that does not associate profile with query, without loss of this information. It is expected that training sets can be dropped sooner; as a result, so that privacy can be enhanced.

At one extreme only one searcher's Profile, Query, & SERP are used to do training at a time. This would be done following each search session; then the training set is dropped. The quicker a training set is dropped the better the privacy, since this means there is less time a searcher's profile and query are stored within Grabhat Cloud. The less time the query and profile are stored in a manner that associates one with the other, the less exposure for the searcher should a ‘bad actor’ gain unauthorized access to training sets.

Maximizing privacy would require minimum training set storage, or training/re-training with a single training set, following each individual search session. This could potentially lead to a need for thousands, perhaps millions of generations of ANNs to be pre-trained, stored and used during each training session. This could be prohibitive in terms of storage cost and/or execution time.

The system can therefore use each new training set, incrementally, in process, to test the existing collection of generational ANNs. If the new (current) training set is properly classified by the ANNs when ganged together, then there is no need to store it for training and it can be dropped immediately. If it is not correctly classified, then it can be temporarily stored for training a new ANN “added on”.

At the other extreme, training sets could represent thousands or millions of search sessions, which would require storage of the sets for a time. Storage time may also be dependent on the number of searchers and frequency of their use of Grabhat. This extreme reduces privacy, but likely leads to faster training time and/or less storage space consumption. The loss of privacy by the latter approach is due to the need to store searcher query and their profile together for a longer period of time.

Several queries from the same profile, in a short period of time, each impacting the rank of the same set of search result abstracts (URLs) might be an attempt to game Grabhat's ranking mechanism for unfair advantage to certain URLs. If the same exact profile is responsible for search sessions impacting the same URL's rank, then the system does not use associated searcher inferred SERP rankings to update our Ranking ANN. The one-way hash can be a combination of the entire contents of the searcher's profile combined with the URL having inferred rank impact. It is possible that two individuals can have the exact same profile can independently conduct search sessions and have an inferred rank impact to the same URLs. The database is keyed by time-of-day (TOD) to the nearest month; and 1^{st} language of the searcher, can be maintained. Use of the 1^{st} language as a key is expected to reduce time for look-ups in the database. The use of TOD as a key can also serve to speed-up database look-up time.

The resulting one-way hash can thus be relatively unique, with fairly high probability; and cannot be used to reconstitute the searcher's profile. This can be done for every search session, and every URL who's inferred rank is impacted. If there is a match between the current resulting hash and any previous hashes, no update to this hash database can be made, and the corresponding Ranking ANN training set may not be used. If there is no match, then the training set can be used for training. A Hash Database garbage collection mechanism can be implemented. It can track the lifetime of each stored hash. When a lifetime expires for a hash, the next clean-up or garbage collection cycle can delete old hashes from the database. Since TOD is used as a key ‘garbage collection’ or deletion of the older hashes in the database is simplified. The system can delete all hashes that are more than two months old. The granularity of the TOD key and frequency of garbage collection can be adjusted to better support the number of search sessions and database size limitations as experience is gained, and searcher use grows.

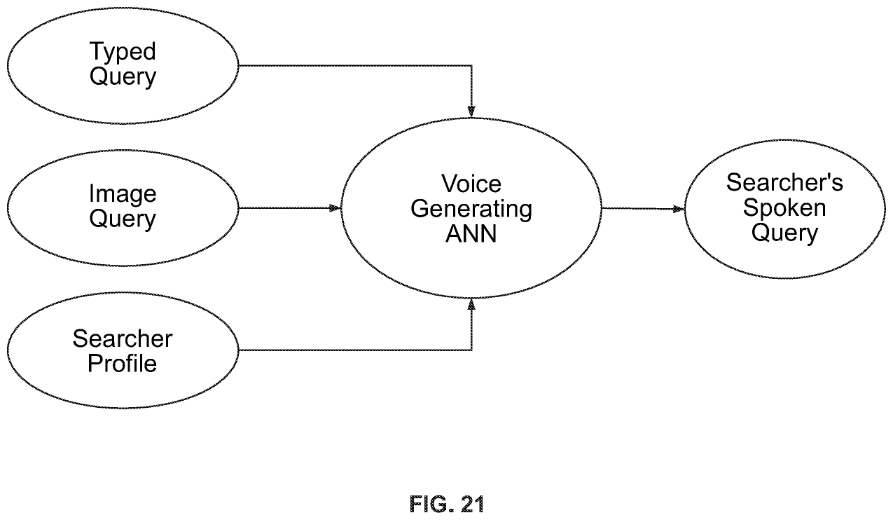

The purpose of the Composite Profile Voice ANN is to take as input training sets the profiles and queries (typed & image-based), using searcher voice queries as the output, and train the ANN to model a composite voice based on searcher profile. The searcher can enter the query as text, image, or voice. It is unlikely that a searcher can enter more than one form of query, but the system can use it if they do. If they enter only one form of query and it is a voice query, from the voice the system can generate a text version and an image version of the query using open source tools. The system can then use the text and image versions of the query, along with the searcher's profile to train the ANN, as shown in FIG. 21, which is an illustration showing a composite profile voice generation, using the searcher entered voice query as an output. The goal is to train the ANN with many such training sets, such that the ANN is trained to generate a spoken query in a sort of composite profile voice. If the searcher has not entered a profile, the system can use a standard dummy profile with ‘neutral’ inputs and train with that. It is expected that this composite profile-based voice query can be better (i.e. contain more information that relates it to a specific profile) than a voice generated from image or text using commercial off the shelf tools. For searchers who use only text or image query, the generated voice query can be used as an input to the Ranking ANN to re-rank the SERP. An ANN trained in this way, can serve as a means of checking a user's voice against their query, to detect attempts to game the system.

For example, in the case that a ‘black hat’ searcher enters a voice query and a profile, the above described ANN can determine how well the voice query matches the profile. If the ANN produces a large error signal using the profile as input, when compared to the received voice query, this may be an indication of gaming.

Contradicting training patterns may be due to a lack of detail in the standard profile used, but may also be an indication of attempts to game the system. A contradiction occurs when identical profiles and queries generate essentially opposite ResultRank.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

What is claimed is:

1. A method of ranking search results, comprising:
receiving search results; and
ranking the search results using an artificial neural network (ANN), wherein at least one of the inputs to the ANN is derived from a search query, and wherein the search query is processed as a visual image.

2. The method of claim 1, wherein at least one input into the ANN comprises a user's profile.

3. The method of claim 1, wherein at least one input into the ANN comprises a search engine results page (SERP) produced by a search engine and presented to a user for review.

4. The method of claim 1, wherein an output of the ANN comprises a re-ranking of an input SERP.

5. The method of claim 1, wherein a user opinion of the relevance of search abstracts contained in the SERP is inferred while monitoring the user's interaction with an initially provided SERP.

6. The method of claim 5, wherein the ANN is trained to match an output SERP which was re-ordered based on an inference of the user's opinion of the relevance of the result abstract order, in a SERP with which the user interacted.

7. The method of claim 1, wherein training and usage of the ANN is done concurrently and incrementally with each search session.

8. The method of claim 1, wherein training and usage of the ANN is done in batch mode, periodically after saving results from multiple search sessions conducted by a plurality of users.

9. The method of claim 1, wherein the ANN is structured as a convolutional neural network.

10. The method of claim 1, wherein the search query is processed or represented as a grayscale image.

11. A method of ranking search results, comprising:
receiving search results; and
ranking the search results using an artificial neural network (ANN), wherein at least one of the inputs to the ANN is a query provided by a user, in the user's voice as spoken natural language, and wherein the query is an input as voice to the ANN without being converted to a character string.

12. The method of claim 11, wherein the ANN is structured as a Recurrent Neural Network (RNN) made of units of Long Short-Term Memory (LSTM).

13. The method of claim 11, wherein the query is processed or represented as a color image for input to the ANN.

14. The method of claim 11, wherein the ANN identifies a beginning of a series search sessions, conducted by the user, that constitute a Query Language Progression (QLP).

15. The method of claim 11, wherein the ANN identifies a conclusion of a series of search sessions, conducted by user, that constitute a Query Language Progression (QLP).

16. The method of claim 11, wherein the ANN creates Suggested Alternate Query (SAQ) language suggestions based on a user profile and a QLP a user is engaged in.

17. The method of claim 11, wherein a number of URLs in the SERP are based on how deeply the user delves into the presented SERP for review as long as a number of SERPs are less than a maximum number of preset search results based on considerations of cost and execution time of training the ANN.

18. A method of training an artificial neural networks (ANNs), comprising:
training a first ANN based on a first set of training patterns;
deleting the first set of training patterns;
collecting a second set of training patterns; and
operating the first ANN trained on the first training patterns to train a second ANN based on the second set of training patterns.

19. The method of claim 18, comprising freezing weights of the first ANN and adding first outputs from the first ANN to second outputs from the second ANN to train a third ANN.

20. The method of claim 18, wherein the first ANN and the second ANN generate a new training pattern for training a further ANN, wherein the new training pattern can be deleted without excess loss of information.

21. The method of claim 20, wherein a training set is used as a test set for the first ANN and the second ANN such that if the test set obtains acceptable results, further training is suspended.

22. A method of training an artificial neural network (ANN), comprising:
using a user's higher information content form of query as the output of an ANN; and
using a user's profile and lower information content form of query as inputs to the ANN.

23. The method of claim 22, wherein the higher information content form of query is the user's voice query and the lower information form of query is the user's image query.

24. The method of claim 22, wherein the higher information content form of query is the user's image query and the lower information content form of query is the user's text query.

25. The method of claim 22, wherein the ANN is used to generate a higher information content form of query, given the user's lower information content form of query and profile as input.

26. The method of claim 22, wherein the user's profile is not provided as an ANN input.

27. A method of training an artificial neural network (ANN), comprising:
using a user's profile as the output of the ANN; and
using a user's query as the input to the ANN to train the ANN.

28. The method of claim 27, wherein the user's query is in voice form.

29. The method of claim 27, wherein the user's query is in image form.

30. The method of claim 27, wherein the user's query is in text form.

31. The method of claim 27, wherein an error signal between a generated profile and an actual profile is sufficiently large to indicate the generated profile is an attempt to game the search engine.

32. The method of claim 31, wherein the generated profile is used as input to the ANN when the user chooses not to provide a profile
